(19) United States
(12) Patent Application Publication
(10) Pub. No.: US 2010/0168880 A1
(43) Pub. Date: Jul. 1, 2010

(54) Apparatus of combined online music player and chip card reader, and online payment system and method using the same

(76) Inventors: Chien-Hung Liu, Banciao City (TW); Chi-Chen Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,805

(22) Filed: Jun. 22, 2009

(30) Foreign Application Priority Data
Dec. 26, 2008 (TW) 97150842

(51) Int. Cl. G06F 17/00; G06Q 40/00; G06Q 30/00; G06Q 20/00; G06Q 50/00; G05B 19/00

(52) U.S. Cl. 700/94; 705/41; 705/26; 340/5.1

(57) ABSTRACT

An apparatus of combined an online music player and a chip card reader, and an online payment system and the method are disclosed. Particularly, a network-platform agent program is employed to activate an online music playing unit and a chip card reading unit disposed inside the apparatus. The apparatus provides the chip card reader an environment linking to network, so the user may use the chip card with deposit of money to process online trade and payment through the chip card reading unit. It is featured that no further user authentication or transmission of personal data is required. According to the preferred embodiment, the apparatus of combined online music player and chip card reader are provided to link to a network information service platform via the agent program. Therefore, the invention provides an easy way for the user using the apparatus to process the trade and payment on the platform.

### BACKGROUND OF THE INVENTION

1. Field of the Invention

The present invention relates to an apparatus of combined online music player and chip card reader, and an online payment system and method using the same, more particularly to utilize the chip card reader installed on the music player to process online payment.

2. Description of Related Art

On the premise of network security, many online services with the aid of Internet are getting well-developed. The consumers gradually accept spending money using the online payment. Those online commercial activities are like shopping on the network market, auctioning on the bidding site, and some banking activities on the network bank, including transferring account, paying fees, checking balance, buying shares and funds.

No matter what the provided mechanisms of online payment, a doubtless safe network environment is requisite, so as to guarantee the consumers' rights and interests. One of the mechanisms is to utilize a chip card reader, which is connected with a computer system, to authenticate a user's identity. Especially a user interface of a network browser is used to perform a payment mechanism on a shopping platform. The chip cards, such as a credit card, a banking card, or an electronic wallet, provide the like payment mechanism. Moreover, a special electronic wallet used in a convenience store further adopts a proprietary line to perform its payment mechanism.

Reference is made to FIG. 1 showing a schematic diagram of a conventional card reader connecting to a network. This example shows a consumer's behavior, where he utilizes a card reader 14 to access a chip card 18, and the card reader 14 is connected to a computer system 10 linked to a network 11. The computer system 10 links to the network 11 through a data modem 12. The chip card 18 is functioned with the chip card an electronic wallet, or a banking card, and connected to the computer system 10 through the card reader 14. Thereby, the consumer may use the chip card 18 to access a remote server (not shown in the figure). More, some identification or authentication process is required for further payment activity on the server.

FIG. 2 shows a diagram related to a system regarding the electronic wallet of the prior art. Wherein, a consumer 21, service provider 23, and an information server are included, and described in TW patent No. 483279, which discloses a technology in relation to the electronic wallet. The service provider 23 provides many kinds of online services. Via a connection 204, a network-linked information server 25 is provided to store the data related to the services. The data stored in the information server 25 has a database having users' authentication data, audio and video content, and product information. Under the services, the consumer 21 connects to the service provider 23 via the network. The consumer 21 next signs up the server with the registered information (via a connection 202), that has the personal data, identification (ID), and password. Then the service provider 23, via a connection 203, stores the information into the database of the information server 25.

Next, the consumer 21 may buy the products or services through the service provider 23. The service provider 23 firstly requires identifying the consumer 21 via a connection 201. Then the consumer 21 is authenticated through an interface provided by the service provider 23. In which, via a connection 206, the authentication information is inputted to the information server 25. The information server 25 then identifies the consumer 21 in comparison with the consumer's data. After that, the consumer 21 acquires the information service via the connection 205. In this example, the consumer 21 may buy the tickets using the electronic wallet with deposit of money, and this mechanism may extend to other shopping activities.

The mentioned consumer 21, service provider 23, and information server 25 form a payment mechanism providing a more secure consuming mode with an electronic wallet or credit card. However the mechanism generates a very complicated authentication procedure that also affects the consumer's will to do the shopping, especially if the consumer merely uses micropayment.

### SUMMARY OF THE INVENTION

Many applications for an electronic wallet are widespread. In view of many conventional problems of unsmooth or complicated procedure occurred as reaching a safe consuming mechanism, the present invention provides an apparatus of combining an online music player and a chip card reader. Furthermore, an online payment system and a method using the apparatus are disclosed.

The well-known current application is the chip card, such as the smart card used for the rapid transit system, having function of depositing money. There is no need of any authentication procedure or transmitting any personal information when the mentioned chip card with deposit of money is used. Since this mechanism adapts to a common micropayment, it may promote a simple and convenient consumption behavior. According to the preferred embodiment, the claimed apparatus combines an online music player and a chip card reader, which jointly use the same data transmission channel and the power supply. Therefore, it is more convenient to use the chip card to perform an online payment. The present invention has an advantage of listening to the online music and online trade simultaneously.

One of objects of the present invention is to provide a payment system using the apparatus of combined online music player and chip card reader. The payment system in a preferred embodiment has a network information service platform providing a remote information service. Further, a network platform agent program is introduced in the computer system in the user end, thereby to connect with the mentioned network information service platform.

The computer system connects to the online music player via a connecting interface. In the preferred embodiment, the player has a loudspeaker, and includes an identification code burned into the player's firmware. When the online music player establishes an electric connection to the computer system, the network platform agent program may be automatically or manually initiated. The computer system may automatically connect to network and download the music stream from the network information service platform by the network platform agent program. Since the program further drives the apparatus of combined online music player and chip card reader, thereby the chip card reader can link to the service platform via the network by the apparatus. Users may use the described apparatus to perform further consumption activity.

The apparatus of combined online music player and chip card reader applied to the payment system includes an online music playing unit and a chip card reading unit. The online music playing unit has an identification code used for the network information service platform's recognition. The music playing unit further includes a data transmission interface linking to the computer system, an audio processing unit operating a digital-to-analog conversion on the streaming music, a memory unit for buffering data, and a speaker. The chip card reading unit links to the online music playing unit via a connecting interface. Further, this chip card reading card may connect to the network information service platform via its connected computer system. More, an interface directed to the computer system is jointly used for both the online music player and the chip card reading unit. Further, the power supplied to the computer system also jointly supplies both units.

According to a further embodiment of the present invention, the aforementioned payment system is applied to an online payment method. In the beginning of performing the method, the online music player and the chip card reader are connected. The apparatus of combined online music player and chip card reader electrically connects to the computer system, and thereby connects to network. Next, a network platform agent program is executed in the computer system, and is sued to initiate the online music player and the chip card reader. After that, the apparatus connects to the information service platform. Through the network platform agent program, the inside online music player downloads the data stream, especially the streaming music or other audio signals.

After selecting the merchandise at the above-mentioned electronic commerce platform, data in the chip card can be accessed since the chip card reader is powered and initiated. In the preferred embodiment, data in the chip card can be read by contact or contactless means. After verifying the chip card's signal, the network platform agent program is incorporated into connecting to the network information service platform. So that, the method provides a mechanism to perform the trading activity and payment without need of personal authentication or transmission of personal data.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 shows a diagram of a card reader connected to a network of the prior art;

FIG. 2 shows a related connection diagram regarding to an electronic wallet of the prior art;

FIG. 3 is a schematic diagram of an online payment system combined with an online music player and a chip card reader of the preferred embodiment of the present invention;

FIG. 4 shows a schematic diagram of the connection between the apparatus of combined online music player and chip card reader, and the relevant peripherals of the preferred embodiment;

FIG. 5 shows a functional block diagram of the apparatus of combined online music player and chip card reader of the preferred embodiment of the present invention;

FIG. 6 shows a schematic diagram of the online payment system implemented by the claimed apparatus of combined online music player and chip card reader;

FIG. 7 is a flow chart of the online payment method implemented by the claimed apparatus of combined online music player and chip card reader.

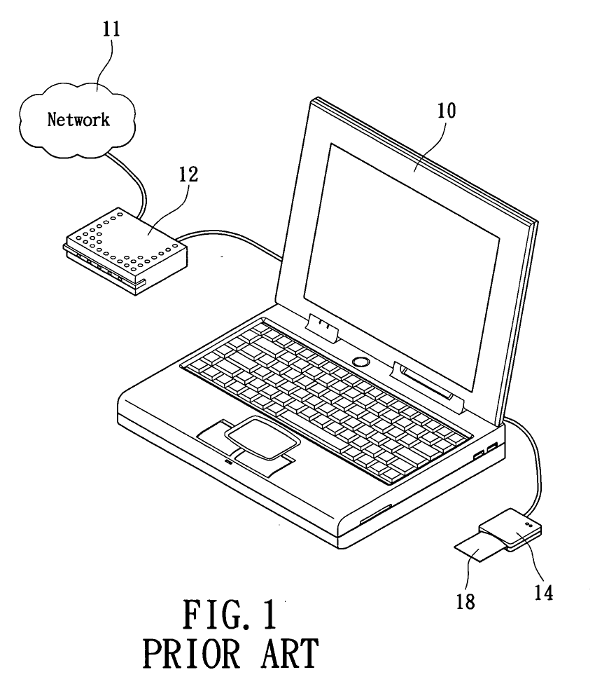

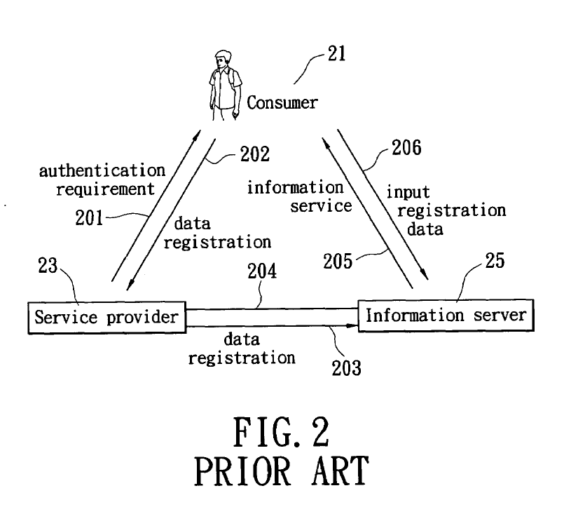

### DETAILED DESCRIPTION OF THE PREFERRED EMBODIMENTS

It's different from the trading mechanism requiring authentication and transmission of personal data made by the prior art, the present invention provides an apparatus of combined online music player and chip card reader. Further, an online payment system and a method using the claimed apparatus are further provided. One of the preferred embodiments of the present invention is to use the chip card with deposit of money, such as the smart card used for the rapid transit system or other electronic wallet with similar function. Under this mechanism, there is no need of authentication nor transmission of personal data when a consumer is proceeding online trading. The present invention provides a simple and convenient consuming circumstance since the simplified payment procedure is used with the apparatus of combined online music player and chip card reader.

The claimed system and method can provide a secure payment environment but without any need of authentication or transmitting the personal information. Under this environment, the consumer's personal information can be well protected. The preferred embodiment is to deduct money directly from the deposit recorded in the chip card, and further to verify the amount by a server of the service provider. Thus this mechanism is suitable to the solution of micropayment.

In view of the structure, the apparatus is to integrate the functions of the online music player and the chip card reader. The combined online music player and the chip card reader use the same signaling channel to connect to a computer system, such as a desktop computer, notebook computer, portable computer system or mobile phone. Further, the online music player and the chip card reader are jointly powered. Thus it is very convenient to users to perform the online payment and listen to the streaming music at the same time.

It is featured that a single network platform agent program is provided to simultaneously drive the online music player and the chip card reader rather than to drive them separately using respective drivers. It is noted that the features provide an original invention since it uses the single program to integrate the structural combination.

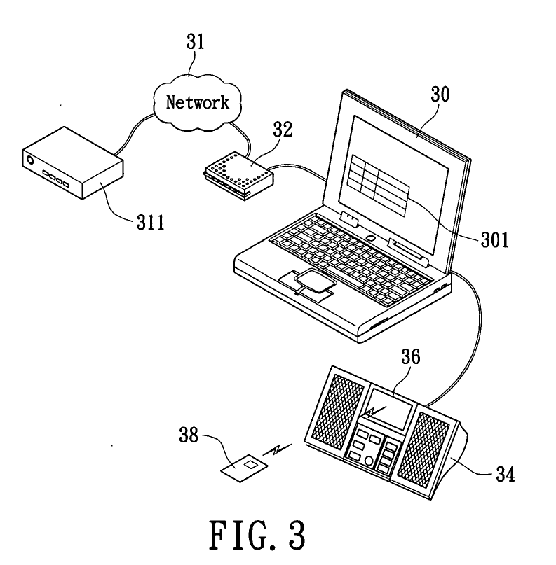

Reference is made to FIG. 3 showing a schematic diagram of the preferred embodiment of the claimed online payment system. A data modem 32 is shown to provide a computer system 30 to connect a network 31. An online music player 34 and a chip card reader 36 disposed thereon are electrically connected to the computer system 30. Through a network platform agent program 301 installed in the computer system 30, both online music player 34 and chip card reader 36 are simultaneously initiated. Further, the apparatus is driven thereby to link a network information service platform 311 and download the streaming music or other audio data. Users may send data to the network information service platform 311 via a chip card 38.

The payment system shown in FIG. 3 utilizes the apparatus combining the online music player 34 and chip card reader 36 to provide the online payment scheme. The online music player 34 is provided with a speaker, and a connecting interface, USB is preferred, to connect to the computer system 30. The computer system 30 also provides power to the player 34 through the connecting interface. Since the chip card reader 36 is mounted on the online music player 34, it may use the same power from the computer system 30 through the interface. It is noted that the structural relationship shown in the figure is not used to limit the possible embodiments.

The preferred embodiment shown in FIG. 3 has a network information service platform 311, by which a remote information service is provided. In the form of a network mall, the online streaming music, data downloading, product shopping, and ticket affair are provided. The network platform agent program 301 is installed in the computer system 30, and used to be a user interface linking to the network information service platform 311. Especially a kind of interactive user interface is incorporated to provide the information service. In another embodiment, the network platform agent program can initiate a network browser in the computer system, and perform the information service therethrough.

The online music player 34 has a proprietary identification code (briefed as ID). The ID can be burned into a firmware or recorded into other forms of memories. When the online music player 34 connects to the computer system 30, the network platform agent program 301 can be automatically or manually executed. This program is used for the player 34 to link to the network information service platform 311. As the online music player 34 connects to the network information service platform 311 via network 31, the network information service platform 311 can identify every online music player 34 by the proprietary ID. It is featured that the proprietary ID can be a substitute for the conventional user authentication. By which, the user can get permission to download the streaming music or other data.

Furthermore, a connection between a chip card 38 and the chip card reader 36 is established by contact or contactless means. The users link to a specific online mall, such as the network information service platform 311, through the network platform agent program 301. After any payment activity is done, the network information service platform 311 receives data from the chip card 38 via the online payment system.

In an exemplary example, the mentioned chip card 38 is a chip card capable of depositing money. Through the chip card reader 36, the users can perform online payment for the products or services on the network information service platform 311. Preferably, there is no need to perform any user's authentication or transmit any personal data, but only the network information service platform 311 and content provider (or the server) verifies the deduction. After that, the balance recorded in chip card 38 is changed.

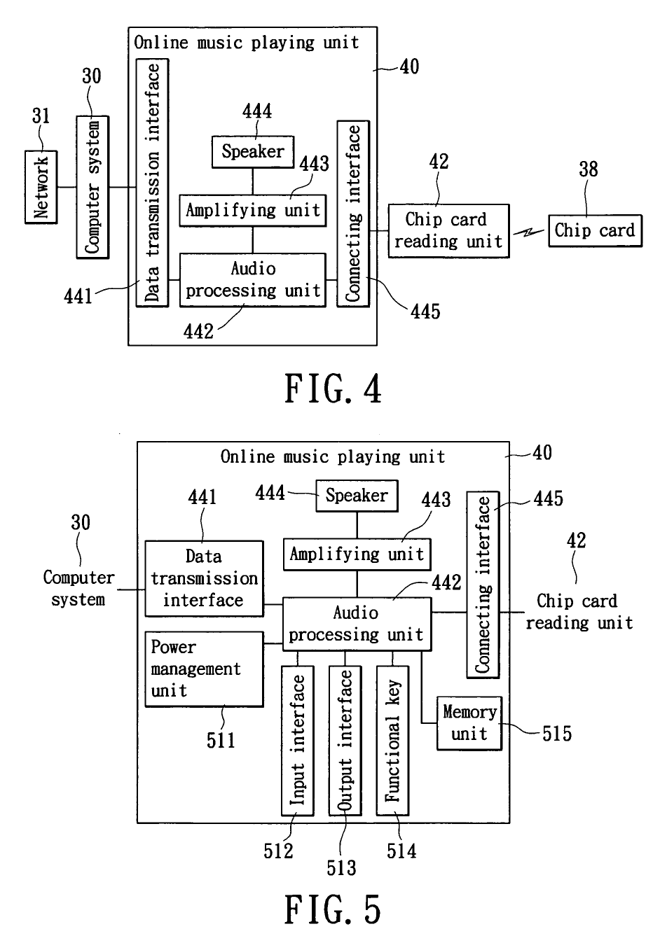

Reference is made to FIG. 4 showing a schematic diagram of the connection between the apparatus of combined online music player and chip card reader, and the relevant peripherals of the preferred embodiment.

The claimed apparatus as shown in FIG. 3 can be structurally separated as the online music player 34 and the chip card reader 36 thereon. In view of the electric circuit, the apparatus has an online music playing unit 40 and a chip card reading unit 42. One end of the online music playing unit 40 electrically connects to the computer system 30, thereby to link to the network 31. Another end of the online music playing unit 40 electrically connects to the chip card reading unit 42. By which, the data of chip card 38 (or the contactless RFID card) is read through the chip card reading unit 42, and sent to the computer system 30 via the online music playing unit 40. Next, the data is transmitted to the network information service platform.

As shown in FIG. 4, the online music playing unit 40 at least includes a data transmission interface 441, a speaker 444, an amplifying unit 443, an audio processing unit 442 and a connecting interface 445, which are electrically interconnected. The data transmission interface 441 can be a universal serial bus (USB) preferably, by which the unit 40 connects to the computer system 30. Through the data transmission interface 441, the online music playing unit 40 and the chip card reading unit 42 are powered from the computer system 30. The online music playing unit 40 is used to download the streaming music or other audio signals, and reproduce music through the amplifying unit 443 and speaker 444. The connecting interface 445 is used to connect to the chip card reading unit 42. In particular, the interface 445 is extended from the data transmission interface 441, so they have the same interfacing standard, such as the USB.

As the above description, the online music playing unit 40 further includes the audio processing unit 442, which is used to perform a digital-to-analog conversion on the streaming music or other audio data. After the conversion, the amplifying unit 443 is used to amplify the outputted analog signals. The speaker 44 is then used to reproduce the music. More, a system processor used to process the signals connects the peripheral devices through the data transmission interface 441 and the connecting interface 445.

FIG. 5 shows a functional block diagram of the online music playing unit 40 of the present invention. The diagram shows the aforementioned data transmission interface 441, speaker 444, amplifying unit 443, audio processing unit 442 and connecting interface 445. Furthermore, a power management unit 511, an input interface 512, an output interface 513, a functional key 514, and a memory unit 515 are included in the audio processing unit 442.

The memory unit 515 electrically connected to the audio management unit 442 is used to buffer the unprocessed streaming signals, or the converted signals. The power management unit 511 is used to manage the power supplied from the computer system 30 via the data transmission interface 441.

The mentioned input interface 512, output interface 513 and the functional keys 514 are provided to the online music playing unit 40 for connecting outside circuits. In an exemplary example, the input interface 512 is used to receive the signals from outside audio sources, such as the microphone, and other analog or digital sources. Further, the output interface 513 is used to connect to the external loudspeaker or other receivers, such as the earphone, HiFi equipment, and the recorders. Further, one or more functional keys are provided to control the volume and electric switch, and the keys may be a volume button, an electric button, or key to initiate a connection. In an exemplary example, the functional key implements a key to initiate a network connection and download the data stream.

The above mentioned ID embedded in the online music playing unit 40 can be the identification data burned into the firmware or memory. As the network connection is established, the ID is used for identifying the claimed apparatus as sent to the network information service platform. It is featured that the chip card reading unit 42 and the online music playing unit 40 particularly jointly employ the power management unit 511 and the data transmission interface 441. Further the units 40 and 42 connect to the network through the computer system 30, by which the consumers may perform the online trade on the network mall.

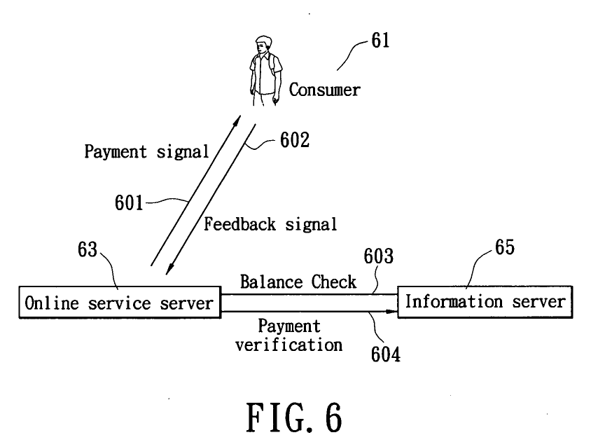

Reference is made to FIG. 6 showing the schematic diagram of the online payment system using the apparatus of combined online music player and chip card reader. A consumer 61, an online service server 63, and an information server 65 are separately shown on the three vertices of the schematic triangle representing their relationship. The online service server 63 represents a platform of a specific online mall, such as the above-described network information service platform providing products and the relevant information. The information server 65 is used to identify the chip card, and verify the payment and the chip card's balance as performing the online payment through the chip card. More particularly, the information server 65 is merely used to identify the chip card, verify the payment, but not to authenticate any user, or check the personal identification.

According to the preferred embodiment, the mentioned consumer 61, online service server 63, and information server 65 are interconnected via a network, and signaling with each other. For example, the consumer 61 connects to the online service server 63 via the network, and this server 63 disseminates the information of products using a user interface. The consumer 61 can make a selection or do a shopping therethrough. When the consumer 61 make the selection and perform a payment using a chip card with deposit of money, the online service server 63 reads the chip card's data through the claimed apparatus. Particularly, there is no need to perform any user authentication or transmit any personal information since merely the chip card is identified in the present invention.

In the exemplary example of processing the online payment, the consumer 61 sends a payment signal (601) to the online service server 63. Since the server 63 merely recognizes the chip card rather than recognizes the user, the identification information is accompanied with the payment signal (601). In the meantime the online service server 63 merely verifies the charge and performs a deduction on the chip card. Furthermore, the consumer can also inquire the balance of chip card to the information server 65 based on the chip card's identification. After that, the information server 65 responds a verification (604) regarding to the balance instantly. Next, the online service server 63 feeds back message (602) to the consumer 61 in order to confirm this payment procedure.

The present invention provides a more simplified payment procedure since the online payment system merely identifies the chip card but not the consumer itself. Therefore, the consumer needs not to process any authentication process and wait for any third-party's authorization, such as a back's authorization. Only the deposit of the chip card is used to verify the payment, so as to avoid blabbing the personal data.

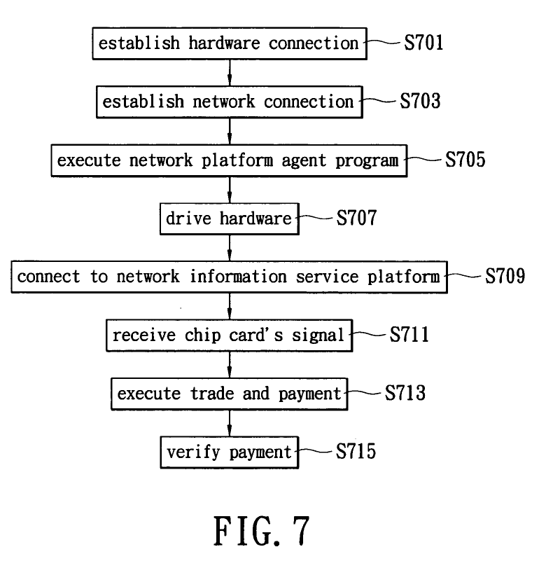

Reference is made to FIG. 7 showing a flow chart of an online payment method of the present invention, especially to employ the apparatus of combined online music player and chip card reader.

In the beginning of the method, an online payment system is established, including the process of establishing the hardware connections between the online music playing unit, chip card reading unit and the computer system (step S701). The computer system then makes a connection to network (step S703). Next, an initialization process is executed after the apparatus electrically links to the computer system. The initialization process includes the step of executing a network platform agent program automatically or by pressing an activation key mounted on the apparatus (step S705). The network platform agent program is used to drive both online music playing unit and chip card reading unit (step S707). In the meantime, the power from the computer system also supplies the apparatus. Through the network platform agent program, the apparatus connects to a network information service platform, which provides various online trading services (step S709). Preferably, the network platform agent program shows an interactive user interface, by which the services provided by the platform are displayed. Users may perform a trading procedure, including browsing, shopping, and payment through the interface. The method further includes a step of downloading stream data after identifying the online music playing unit by an ID.

Since the hardware has been driven and the connection to the network information service platform has been established, the consumer may use the chip card to perform the online payment. The claimed apparatus can receive signals from the chip card as the chip card approaches the chip card reading unit in a certain distance (the contactless way), or the chip card is inserted into the chip card reading unit (the contact way) (step S711). Next, the consumer may perform the online trading and payment (step S713). After that, the network information service platform inquires the chip card's balance from an information server, and verifies the related deduction. Then the information server confirms the payment with the consumer (step S715).

In particular, after the trading process is performed on the aforementioned network information service platform, merely a deduction recorded in the chip card is inquired by the system in a one-way procedure. The chip card may be the smart card used for the rapid transit system, or the electronic wallet with deposit.

To sum up the above description, the present invention relates to the apparatus of combined online music player and chip card reader, and the relevant online payment system and method. The player and the reader jointly use the same interface connecting to the computer system, and use the power supplied from the computer system. Through the integration made by the network platform agent program, both player and reader can be driven to connect the online service server, so as to perform further trading process.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An online payment system, comprising:
an apparatus of combined online music player and chip card reader, integrating an online music playing unit and a chip card reading unit, electrically connecting to a computer system, wherein the chip card reading unit is used to read data from a chip card;
a network information service platform, providing a remote information service via a network, and providing a user interface for a user's selection and payment;
a network platform agent program being executed in the computer system, driving the apparatus of combined online music player and chip card reader for connecting to the network information service platform via the network; and
an information server, connected to the network information service platform via the network, and providing the platform to verify balance of the chip card's deposit.

2. The system of claim 1, wherein the chip card is an electronic wallet with deposit of money.

3. The system of claim 1, wherein the chip card is an RFID card.

4. The system of claim 1, wherein the network information service platform provides information services through an interactive user interface appeared by executing the network platform agent program.

5. The system of claim 1, wherein the online music player has an ID used for identification by the network information service platform.

6. An apparatus of combined online music player and chip card reader, comprising:
an online music playing unit, wherein the unit includes an ID used for identification by a network information service platform, and the unit further includes:
a data mission interface used for the apparatus connecting to a computer system;
an audio processing unit used to perform an analog-to-digital conversion to the downloaded streaming music signals;
a memory unit electrically connected to the audio processing unit, and used to buffer the undealt streaming music signals;
a speaker used to output the converted streaming music signals; and
a chip card reading unit connected to the online music playing unit through an interface, connecting to the network information service platform via the network by the computer system;
wherein the online music playing unit and the chip card reading unit share the interface to connect the computer system, and jointly share power supplied by the computer system.

7. The apparatus of claim 6, wherein the apparatus is driven by a network platform agent program.

8. The apparatus of claim 6, wherein the chip card reading unit is the device to access an RFID card.

9. The apparatus of claim 6, further including: an amplifying unit electrically connected to the data transmission interface, and used to amplify the outputted analog signals; and a power management unit electrically connected to the data transmission interface, used to acquire the power supplied by the computer system through the data transmission interface.

10. The apparatus of claim 9, further comprising: an input interface used to receive the signals from an external audio source; an output interface used to output the signals via an external speaker; and one or more function keys used to control the online music player's volume and switch.

11. The apparatus of claim 6, wherein the chip card reading unit accesses a chip card by contact or contactless means.

12. The apparatus of claim 6, wherein the online music playing unit and the chip card reading unit are driven by a network platform agent program.

13. A payment method adopting an apparatus of combined online music player and chip card reader, comprising:
establishing a hardware connection, which connects the apparatus with a computer system, thereby links to a network;
executing a network platform agent program in the computer system;
driving an online music playing unit and a chip card reading unit disposed in the apparatus;
connecting to a network information service platform through the network platform agent program;
accessing a chip card via the chip card reading unit;
verifying a signal from the chip card, and performing a trade and a payment through the connection between the network platform agent program and the network information service platform; and
acquiring a balance and a deduction of the chip card from an information server via the network information service platform.

14. The method of claim 13, wherein the network platform agent program is executed automatically when the apparatus of combined online music player and chip card reader connects to computer system.

15. The method of claim 13, wherein, when an identification code loaded in the online music playing unit is transmitted in the step of establishing the hardware connection, in order to complete the connection.

16. The method of claim 15, wherein the apparatus acquires the streaming data after verifying the identification code.

17. The method of claim 16, wherein the streaming data is a music stream.

18. The method of claim 13, wherein the chip card reading unit accesses the chip card by contact means.

19. The method of claim 13, wherein the chip card reading unit accesses the chip card by contactless means.

20. The method of claim 13, wherein the network information service platform displays an interactive user interface for trading and payment through the network platform agent.

21. The method of claim 13, wherein the chip card reading unit is used to access an RFID card.
